(19) United States
(12) Patent Application Publication
(10) Pub. No.: US 2012/0293606 A1
(43) Pub. Date: Nov. 22, 2012

(54) TECHNIQUES AND SYSTEM FOR AUTOMATIC VIDEO CONFERENCE CAMERA FEED SELECTION BASED ON ROOM EVENTS

(75) Inventors: Josh Watson, Seattle, WA (US); Simone Leorin, Redmond, WA (US)

(73) Assignee: MICROSOFT CORPORATION, Redmond, WA (US)

(21) Appl. No.: 13/112,691

(22) Filed: May 20, 2011

(51) Int. Cl. H04N 7/15

(52) U.S. Cl. 348/14.16; 348/E07.085

(57) ABSTRACT

Techniques for automatically selecting a video camera feed based on room events in a video teleconference are described. An embodiment may receive video information from multiple cameras in a conference room. An event of interest may be detected from the video information. Events of interest may be detected, for example, by detecting faces, detecting an eye gaze or head direction, and detecting motion. When an event of interest is detected, the video camera having the optimal view of the event may be selected, and the feed from the selected video camera may be transmitted to remote participants. Other embodiments are described and claimed.

### BACKGROUND

A conference room used for a video teleconference may have two or more cameras, each with its own viewing area of the room. At any given moment, the activity of interest in the conference room may change location, for example, as different people speak, or among speakers and visual aids, such as posters or projected images in different part of the room. Remote viewers may wish to see the current activity or focal point of interest to have the same context as those in the room. Selecting a video source to feed to remote viewers is conventionally a manual process of selecting a camera that has a view of the active speaker, a white board, or other activity of interest in the room. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are directed to systems and techniques for automatically selecting a video camera feed based on room events in a video teleconference (VTC). An embodiment may receive video information from multiple cameras in a conference room. An event of interest may be detected from the video information, such as an active speaker, a visual focal point, presence in a presentation location, and so forth. Events of interest may be detected, for example, by detecting faces combined with eye gaze and/or head direction, detecting motion (e.g., movement toward a presentation area), and other event cues. When an event of interest is detected, a video camera having an optimal view of the event is selected, and a feed from the selected video camera is transmitted to remote participants. Considerations that may affect camera selection may include, for example, camera resolution, distance to the event, the view of the event, and camera location, among others.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a system for automatic video camera selection for a video teleconference.

FIG. 2 illustrates a block diagram of a video teleconferencing system according to embodiments.

FIG. 3 illustrates an example of a conference room layout for a video teleconference according to embodiments

FIG. 4 illustrates an example of a logic flow according to embodiments.

FIG. 5 illustrates an example of a logic flow for camera selection according to embodiments.

FIG. 6 illustrates an embodiment of a computing architecture.

FIG. 7 illustrates an embodiment of a communications architecture.

### DETAILED DESCRIPTION

Various embodiments are generally directed to techniques and systems to automatically select a video camera feed based on room events in a video teleconference (VTC). Some embodiments are particularly directed to an apparatus to conduct a video teleconference, detect room events, and select a video camera feed based on a detected event. In one embodiment, for example, an apparatus may include a video processing unit to receive video information from multiple cameras, a video conferencing module to conduct the video teleconference, an event detector, and camera selection logic. When the event detector detects an event of interest, the camera selection logic may select a video camera having an optimal view of the event. The selected video camera may then transmit a audio/visual feed to remote participants. In this manner, remote viewers may consistently view a current activity or focal point of interest over the course of a VTC, and as a result have a same or similar context as those physically present in the conference room.

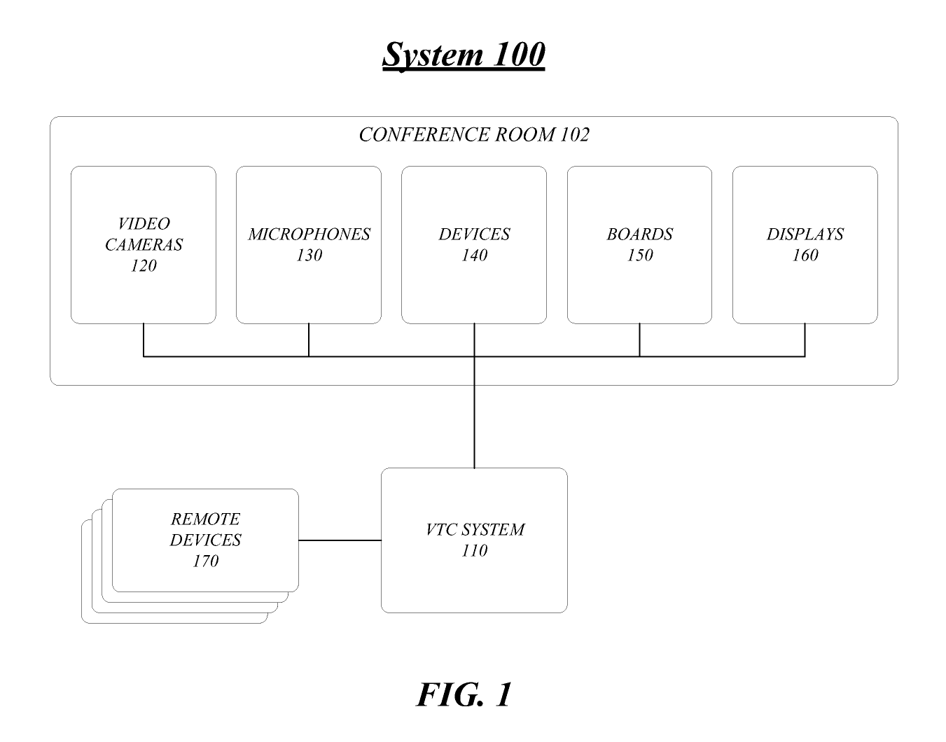

FIG. 1 illustrates a block diagram for a system 100 to automatically select a video camera feed based on room events in a VTC. In one embodiment, for example, the system 100 may comprise a computer-implemented system 100 having one or more components, such as VTC system 110, video cameras 120, and a remote device 170. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented with one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

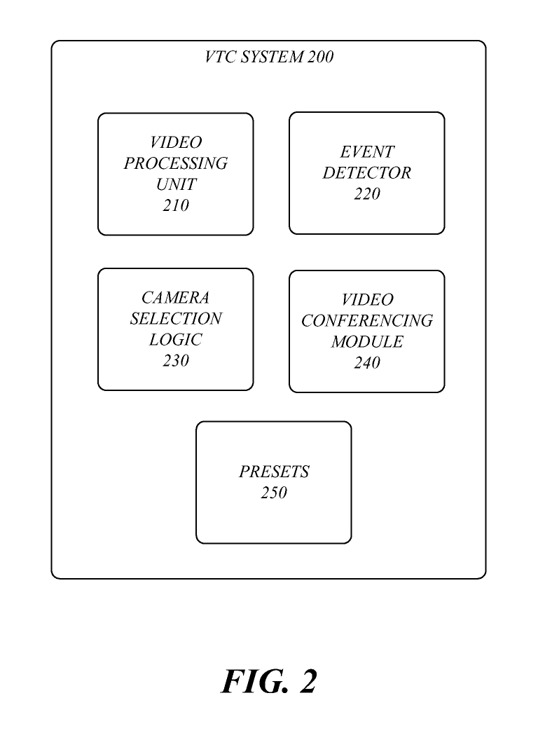

In various embodiments, the system 100 may include a video teleconferencing (VTC) system 110. VTC system 110 may be operative to coordinate a VTC by receiving audio, video, and data information from a conference and transmitting the information to one or more remote devices 170. VTC system 110 may also receive video, audio, and data information from remote participants via remote devices 170, and provide the information to other participants. VTC system 110 may include one or more electronic devices capable of operating a virtual teleconference. VTC system 110 may additionally manage information about who is participating, detect an active speaker, arrange a display of the different video feeds, and other functions of a VTC system. VTC system 110 is described in greater detail with reference to FIG. 2.

System 100 may include various components physical located in a physical conference room 102. The conference room 102 may include, by way of example, one or more video cameras 120, microphones 130, devices 140, boards 150, and displays 160. The conference room 102 may also include other types of conference room equipment, such as projectors, lighting systems, security systems, and so forth. The embodiments are not limited in this context.

Video cameras 120 may include any digital camera capable of capturing video information from a defined field of view and providing the video information to VTC system 110. Examples of digital cameras may include, for example, a fixed camera, a pan-tilt-zoom (PTZ) camera, a camcorder, a tabletop camera, a 360 degree camera, a webcam, a laptop computer built-in camera, a cell phone camera, and so forth. In some embodiments, video cameras 120 may be simple video cameras that record and/or transmit video to VTC system 110 of the participants in the room for a video teleconference, without any internal processing of the video images. For such video cameras, VTC system 110 may perform video processing tasks as needed.

In other embodiments, more sophisticated video cameras may perform pre-processing and/or post-processing of captured video images, thereby reducing computational load for VTC system 110. For instance, video cameras 120 may be “smart” video cameras that perform video processing operations internally, including without limitation face detection, motion detection, image stabilization, video compression, and the like. Video cameras 120 may also measure lighting information such as exposure, color warmth, contrast, brightness, and backlighting. Such video cameras may transmit unprocessed and/or processed video and lighting information to VTC system 110.

Microphones 130 may include any audio input device capable of capturing audio information from an area and providing the information to VTC system 110. Microphones 130 may include, for example, microphones built into a camera, table-top microphones, wearable microphones, cell phone microphones, microphone arrays, and so forth.

Devices 140 may include any electronic device capable of providing displayable content via VTC system 110 to displays 160 and remote devices 170. Devices 140 may include, for example, a computer, a smart phone, a DVD player, a satellite receiver, a cable television receiver, and so forth. Displayable content may include, for example, presentation slides, multimedia presentations, documents, images, television signals, and so forth.

Boards 150 may include any interactive surface in use during a conference. Boards 150 may include, for example, chalk boards, white boards, smart white boards, transparencies, paper pads, and so forth. Boards 150 may generally refer to collaborative surfaces where conference participants may generate content and conference data.

Displays 160 may include any device capable of showing video, audio, and/or computer data to the participants in the conference room. The material to be displayed may be received from VTC system 110. Displays 160 may include, for example, televisions, computer monitors, projection systems, cell phone screens, a liquid crystal display, a plasma display, and so forth. Displays 160 may show the various video feeds from other VTC devices in the conference. In an embodiment, displays 160 may also comprise speakers for the audio information.

VTC system 110 may receive as input data captured by video cameras 120, microphones 130, devices 140, and/or boards 150. VTC system 110 may manage distribution of the captured data such that remote participants can also see the captured data via remote devices 170. VTC system 110 may be in any location where it can receive data from video cameras 120, microphones 130, devices 140 and boards 150, and where it can communicate with other VTC devices that are supporting a VTC from other locations. In an embodiment, none of the components of VTC system 110 may be located in conference room 102. In other embodiments, some or all components of VTC system 110 may be located in conference room 102.

FIG. 2 illustrates a block diagram of a video teleconferencing (VTC) system 200. VTC system 200 may comprise an exemplary embodiment of VTC system 110 as described with reference to FIG. 1. VTC system 200 may include one or more components, such as a video processing unit 210, an event detector 220, camera selection logic 230, a video conferencing module 240, and one or more presets 250.

Video processing unit 210 may include logic that receives raw video data from a camera and performs various functions on the raw data. Such functions may include, for example, video data compression; image analysis to detect, for example, motion, people, and/or faces; color correction; image stabilization; contrast correction; and so forth. Such video processing functions are well known in the art. Video processing unit 210 may additionally process the detected faces to determine a directionality of the faces. For example, video processing unit 210 may determine that a side view of a face is detected, and may determine that the face is looking toward the left side of the video scene. Video processing unit 210 may detect the eyes on a face, and may analyze the detected eyes to determine an eye gaze direction. Video processing unit 210 may be a component of a video camera 120, or may be separate from the video camera 120, for example, as a component of a computing device.

Event detector 220 may include logic that detects events of interest that occur in conference room 102 during a VTC. Event detector 220 may receive processed video from video processing unit 210. Event detector 220 may detect, for example, an active speaker, a location or item in the room that the participants are looking at, a presenter standing near a board or display, a participant standing in a specific location in the room, and so forth. In an embodiment, event detector 220 may be a component of video processing unit 210. In another embodiment, event detector 220 may be separate from video processing unit 210. Event detector 220 may reside on a separate device from video processing unit 210, for example, if video processing unit 210 is a camera component.

Event detector 220 may receive, for example, processed video that includes a direction, e.g. an eye gaze direction or a head direction. Event detector 220 may then correlate the direction with the components of the conference room to determine a target of the direction. For example, if all (or most) of the participants in the room are looking at a display, then event detector 220 may determine the location where the directions of each participant converge and select that location as the detected “event” or target. Event detector 220 may also receive audio information and may detect an active speaker from the audio information alone or in conjunction with video information. Event detector 220 may also receive detected motion from the processed video. The detected motion may be used to detect, for example, a participant moving to a presentation area, such as a podium or near a board. Detected motion may also be used to detect a change in focus or attention, for example, as a conversation moves from one participant to another, turning heads may indicate both that the event of interest, i.e. the speaker, has changed and where the new event is located. Generally, event detector 220 may detect the primary activity in a conference room so that, once the appropriate video feed is selected, remote participants can view the primary activity as though they were in the room, thus enhancing the remote participant's VTC experience.

Camera selection logic 230 may receive a detected event of interest from event detector 220. Camera selection logic 230 may then determine which video camera in the conference room has the optimal view of the detected event. The video feed from the optimal camera may then be selected as a video feed to transmit to remote participants. Camera selection logic 230 may select a video camera according to one or more parameters. The parameters may include, for example, a camera location; a camera field of view; a distance of the video camera 120 to the detected event; a camera's view of the detected event; a zoom; and a resolution.

Camera selection logic 230 may determine an optimal video camera by calculating a score from one or more measures based on the parameters. For example, one measure may be the percentage of a camera's field of view that is filled with the detected event. This percentage may be affected by how close the video camera 120 is to the event, or by the zoom capability of a camera. A camera that is closer to an event than another camera will have a larger part of its field of view occupied by the event. Another measure that may be used is a completeness, in a field of view, of the front of a face associated with the detected event. For example, if the event is an active speaker, one camera that has a view of the speaker may only have a side view of the speaker. Another camera having a view of the same speaker may have a front view, or a 3/4 view, which may be more desirable. Another measure that may be used is a resolution of the video cameras 120 with a view of the detected event. Higher resolution is usually associated with better image quality and may be more desirable. In some cases, however, lower resolution may be desired if transmission resources are constrained. Another measure that may be used is the proximity of the video cameras 120 with a view of the detected event to the detected event. The proximity measure may be a variant of the percentage of field of view measure, and may be more efficient, for example, when distances from cameras to certain locations in the room are known. The measures may each have a numeric value. Percentage-based measures may have values, for example, between 0 and 1. Distance-based measures may have values that are absolute, e.g. three feet. Resolution may be a standardized value, or may be a relative value for the video cameras 120 in the room, e.g. resolution of 1 for the highest resolution camera, and 0 for the lowest resolution camera in the room. The embodiments are not limited to these examples.

In an embodiment, one or more measures may be used together to arrive at a score for a camera. If only one measure is used, for example, the closest camera, then the video camera with the highest score for that measure may be selected. If two or more measures are used, each measure may be weighted, and the score may be a weighted sum of the measures. For example, an optimal camera may be defined as the closest camera that also has a front view of the event. A higher weight may therefore be placed on the completeness measure than the proximity measure. Other methods of scoring the measures in aggregation may be also used.

In an embodiment, VTC system 200 may include a video conferencing module 240. Video conferencing module 240 may perform the coordinating tasks of operating a VTC. In particular, video conferencing module 240 may receive the selected camera from camera selection logic 230, and may use a video switch to send the video feed from the selected camera to the remote participants.

In an embodiment, VTC system 200 may include one or more presets 250. A preset 250 may define the video cameras 120 to select for specific locations in a room. For example, a preset 250 may specify that when the detected event is a person standing next to a white board, that the video camera 120 viewing the white board should be selected. Using presets 250 may reduce the time and calculations needed to determine an optimal camera, and may be most useful in a relatively fixed set-up conference room where the locations of events of interest are predictable.

The components 210, 220, 230, and 240 may be communicatively coupled via various types of communications media to each other and to video cameras 120, microphones 130, devices 140, boards 150, and displays 160. The components may coordinate operations among each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In an embodiment, video processing unit 210, event detector 220, and/or camera selection logic 230 may be components in at least one video camera 120. In such an embodiment, the video cameras 120 may have information about where the other cameras in the room are located. The video camera 120 selected by camera selection logic 230 may be indicated to video conferencing module 240 to affect the remote video feed.

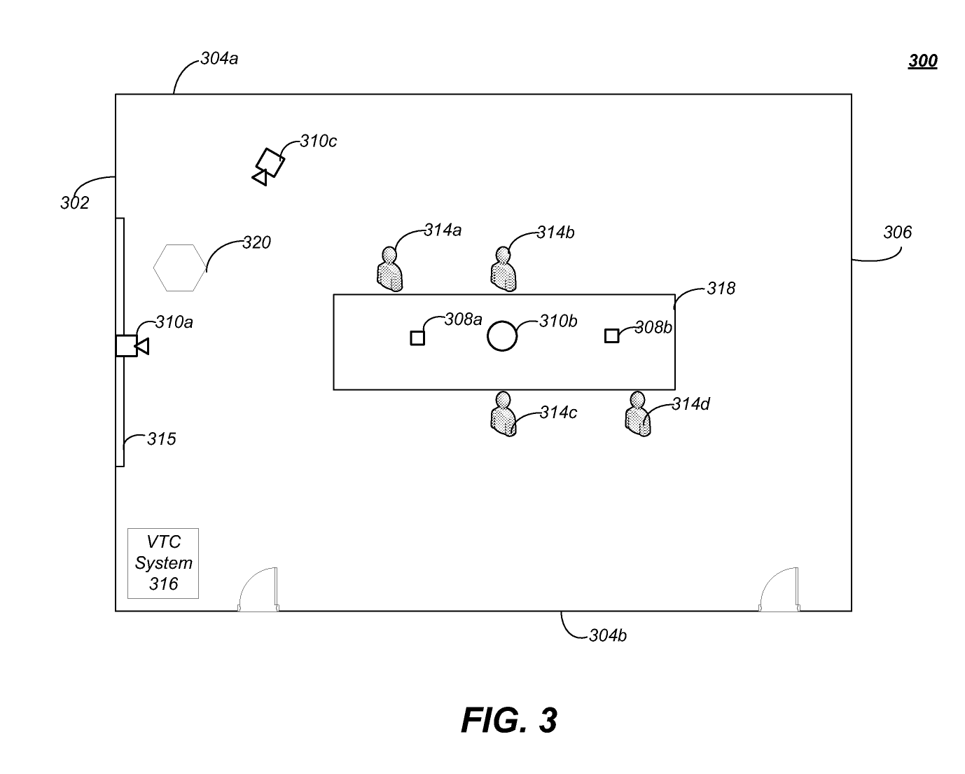

FIG. 3 illustrates a conference room 300 suitable for use in a video teleconference. Conference room 300 may comprise an exemplary embodiment of the conference room 102 as described with reference to FIG. 1. Conference room 300 may include a front wall 302, two side walls 304a, b, and a back wall 306. Conference room 300 may include one or more microphones 308a, 308b, and a number of cameras 310a-c. A camera 310 may include a built-in microphone. Conference room 300 may include a board (or a display) 314. One or more components of a VTC system 316 may be located in conference room 300, or may be located outside of the room but able to receive information from microphones 308 and cameras 310. When a conference is taking place, conference room may have one or more participants 314a-d seated at a conference table 318.

In an embodiment, camera 310a may be a PTZ camera. Camera 310b may be a table-top 360 degree camera that can provide a view of a portion of the room up to a panoramic view of the whole room, such as, but not limited to, the ROUNDTABLE® camera from Microsoft Corp. of Redmond, Wash., or the POLYCOM® CX5000 from Polycom, Inc. of Pleasanton, Calif. Camera 310c may be a fixed focal length camera aimed at and focused on board/display 314. The embodiments are not limited to this example.

Suppose that the four participants seated at table 318 are conversing. They may generally be facing one another, which may be detected by VTC system 316 from the fact that the participants are generally facing camera 310b. Both camera 310a and 310b have a view of all four participants. Camera 310b, however, is closer to the participants, and can provide more of a close-up view of each participant, as well as being able to show most or all of the face of each participant. Camera 310a, being further away, could zoom in to get more of a close-up view, but would lose part of the scene to do so. Further, camera 310a may not be able to show all of the faces of the participants. In this scenario, the detected event is that the participants are facing one camera, and the video camera 120 selected to provide the remote video feed is camera 310b.

Suppose that the four participants are now all facing board/display 314, and that participant 314a is detected as the active speaker. Suppose that the content on board/display 314 is not available to remote participants through other channels of the VTC, for example, if board/display 314 is a conventional white board. The detected event may be that everyone is looking at board/display 314. Camera 310b and 310c both have a view of board/display 314. Camera 310c, however, may be closer, or have a more unobstructed view. Camera 310c may then be selected for the remote feed to remote participants.

If the content on board/display 314 is available through another VTC channel to the remote participants, for example, as a shared presentation, or as a smart whiteboard input, then the detected event may be the detected active speaker. In that scenario, both cameras 310a and 310b have a view of participant 314a, but only camera 310a has a front view of participant 314a while the participant is facing the board. Camera 310a, perhaps panned and zoomed to participant 314a's face, may be selected for the remote feed.

In an embodiment, conference room 300 may have one or more preset locations, such as location 320. When a detected event takes place at a preset location, VTC system 316 may look up which camera to select from presets 250. In FIG. 3, for example, location 320 may be used by a presenter standing in front of board/display 314. When a speaker is detected in location 320, VTC system 316 may automatically select camera 310c, if camera 310c is the video camera 120 associated with location 320 in presets 350.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

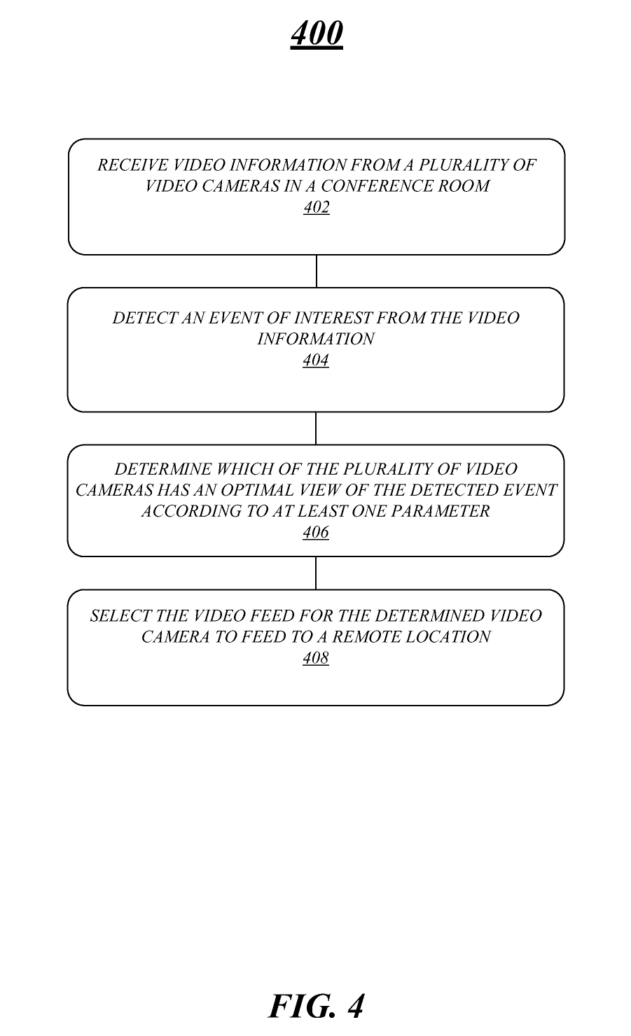

FIG. 4 illustrates one embodiment of a logic flow 400. Logic flow 400 may be representative of some or all of the operations executed by one or more embodiments described herein. For instance, the logic flow 400 may be implemented by VTC systems 110, 200.

Logic flow 400 may receive video information from a plurality of video cameras in a conference room in block 402. For example, VTC systems 110, 200 may receive raw video information from video cameras 120. In another embodiment, VTC system 110 may receive processed video from the video cameras 120, or from another video processing unit.

Logic flow 400 may detect an event of interest from the video information in block 404. For example, if the video information received is raw, then VTC systems 110, 200 may use a video processing unit 210 to process the raw video to detect features, for example, a person, a face, a head direction, an eye gaze direction, a movement, and/or an active speaker. VTC systems 110, 200 may receive processed video that contains such detected features.

From the detected features, VTC systems 110, 200 may further analyze the detected features to detect an event of interest, for example, with event detector 220. Events of interest may be an action or point of focus for the participants in the room, e.g. something in the room that the remote participant would also look at if they were in the room. Events of interest may include, for example, a person standing by a board/display making a presentation, an active speaker, a location in the room that everyone is looking at, a conversation where the participants are looking at each other, and so forth. Events may be detected by determining a direction that a participant is facing (e.g. head direction) and looking at (e.g. eye gaze direction). The directions of each participant may be aggregated or combined to determine the general point of focus for the majority of participants in the room. Eye gaze direction lines may be examined for an intersection point, for example, where the intersection point is selected as the “event” of interest. Direction lines that do not intersect with the others may be discarded, for example, if a participant is looking at his cell phone. The embodiments are not limited to these examples.

In an embodiment, detecting an event of interest includes detecting that an event is occurring at a defined location in the room. The defined location may correspond to a preset item as defined by a preset 250, which may include a pre-determined camera to select for that location.

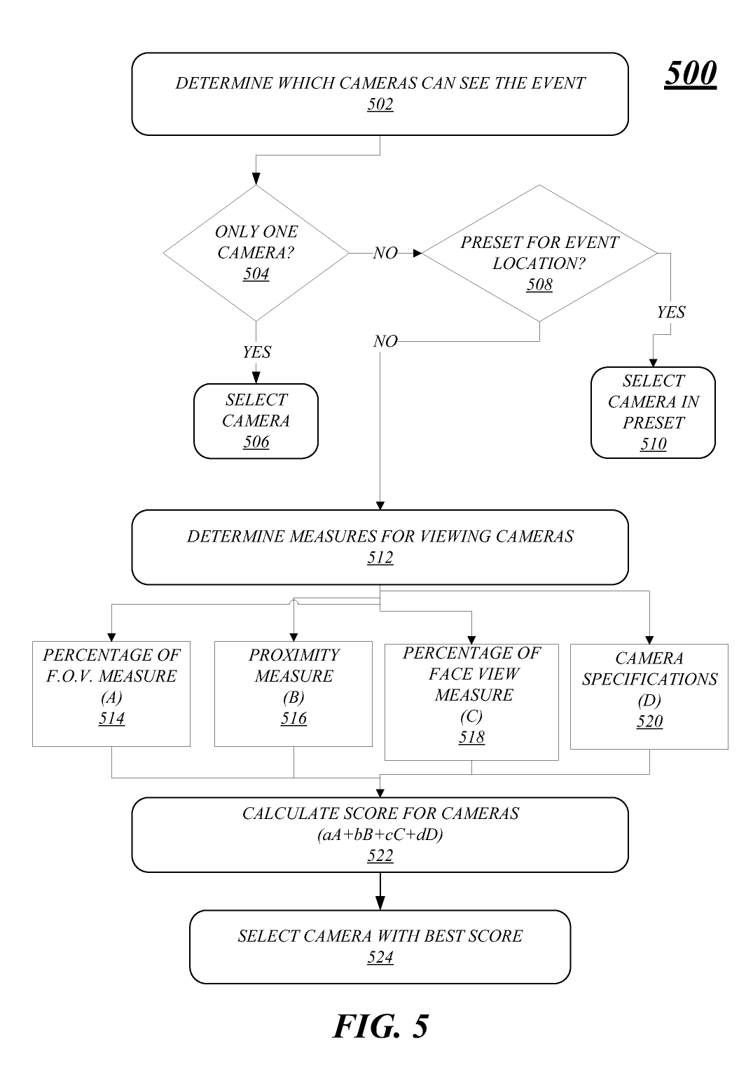

Logic flow 400 may determine which of the plurality of video cameras has an optimal view of the detected event according to at least one parameter in block 406. For example, VTC systems 110, 200 may determine which video cameras 120 have a view of the detected event. Camera selection logic 230 may then compare the views of the event from each video camera 120 to select the optimal view. Camera views may compared on various parameters, including, for example, a camera location; a camera field of view; a distance of the video camera 120 to the detected event; a camera's view of the detected event; a zoom; and a resolution. Camera selection logic 230 may determine, measure, or assign a value to each parameter to obtain measures that can be compared across the video cameras 120. In an embodiment, two or more measures may be considered for each camera. In such an embodiment, the two or more measures may be aggregated to form a single score. For example, the measures may be added together, or weighted and added. The video camera 120 having the “best” score, e.g. the highest score, may be selected. An embodiment of block 406 is described further in FIG. 5 below.

Logic flow 400 may select the video feed for the determined video camera to feed to a remote location in block 408. For example, VTC system 110, 200, or video conferencing module 240 may receive the selected camera from camera selection logic 230, and may use a video switch to send the video feed from the selected video camera 120 to the remote participants 170-n.

FIG. 5 illustrates one embodiment of a logic flow 500. Logic flow 500 may be representative, in particular, of a camera selection process executed by one or more embodiments described herein. The logic flow 500 may be a representative embodiment of block 406 from FIG. 4.

Logic flow 500 may determine which cameras in the conference room can see the detected event in block 502. VTC system 110, 200 may know the locations of the video cameras 120 in the room and which areas of the room are in view for each camera. When the location of the event of interest is determined, VTC system 110, 200 may map the location to the area of the room, and which cameras view the location.

When only one camera can see the event, in block 504, logic flow 500 may select that camera in block 506. When there is more than one camera in block 504, logic flow 500 may check if there if a preset for the location in block 508. If there is a preset for the location, then logic flow 500 may select the video camera 120 specified in the preset for that location, in block 510. When there is no preset, logic flow 500 continues with block 512.

Logic flow 500 may then determine measures for the viewing cameras in block 512. The measures may be measured, calculated, looked up, or assigned, and may each have a numeric value. For example, one measure may be the percentage of a camera's field of view that is filled with the detected event (block 514). This percentage may be affected by how close the video camera 120 is to the event, or by the zoom capability of a camera. A camera that is closer to an event than another camera may have a larger part of its field of view occupied by the event.

Another measure that may be used is the proximity of the video cameras 120 to the detected event (block 516). The proximity measure may be a variant of the percentage of field of view measure, and may be more efficient, for example, when distances from cameras to certain locations in the room are known.

Another measure that may be used is a completeness, in a field of view, of the front of a face associated with the detected event (block 518). For example, if the event is an active speaker, one camera that has a view of the speaker may only have a side view of the speaker. Another camera having a view of the same speaker may have a front view, or a 3/4 view, which may be more desirable.

Other measures that may be used may include various camera specifications (block 520), such as a resolution of the video cameras 120 with a view of the detected event. Higher resolution is usually associated with better image quality and may be more desirable. In some cases, however, lower resolution may be desired if transmission resources are constrained. Other measures may be used in addition to, or instead of, the measures illustrated.

Logic flow 500 may calculate a score for the video cameras based on the measures, in block 522. For example, logic flow 500 may add the measures together. In an embodiment, a weighted sum of the measures may be used. For example, for each of the measures A, B, C, and D from FIG. 5, a corresponding weight a, b, c, and d may be assigned. The weights may be adjusted according to which features of the conference experience are more desired.

Logic flow 500 may select the video camera having the best score in block 524. The best score may be defined, for example, as the highest score, the lowest score, or some other definition related to how the scores are calculated and weighted. The video conferencing module may then use the selection to affect a video switch, causing the feed from the selected camera to be transmitted to remote participants.

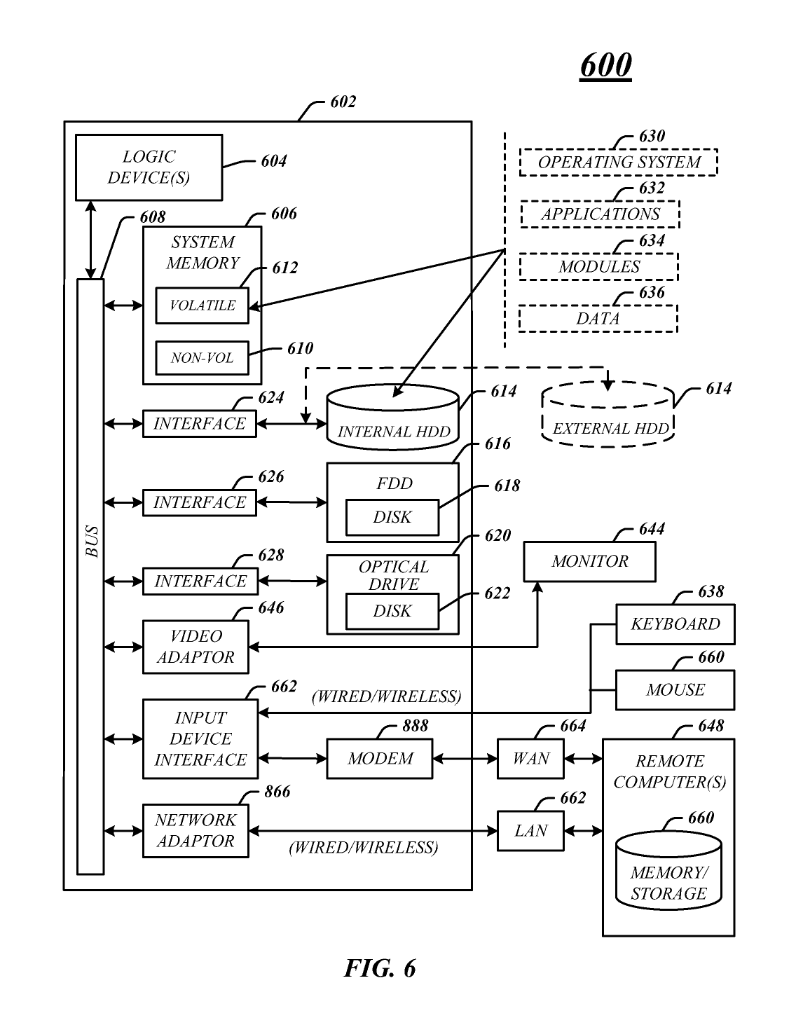

FIG. 6 illustrates an embodiment of an exemplary computing architecture 600 suitable for implementing various embodiments as previously described. The computing architecture 600 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 600.

As shown in FIG. 6, the computing architecture 600 comprises logic device(s) 604, a system memory 606 and a system bus 608. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 604. The system bus 608 provides an interface for system components including, but not limited to, the system memory 606 to the logic device(s) 604. The system bus 608 can be any of several types of bus structure that may further interconnect to a memory bus (with or without a memory controller), a peripheral bus, and a local bus using any of a variety of commercially available bus architectures.

The system memory 606 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media, including an internal hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. The one or more application programs 632, other program modules 634, and program data 636 can include, for example, video processing unit 210, event detector 220, camera selection logic 230, and video conferencing module 240.

A user can enter commands and information into the computer 602 through one or more wire/wireless input devices, for example, a keyboard 638 and a pointing device, such as a mouse 640. Other input devices may include a microphone, an infra-red (IR) remote control, a joystick, a game pad, a stylus pen, touch screen, or the like. These and other input devices are often connected to the logic device(s) 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

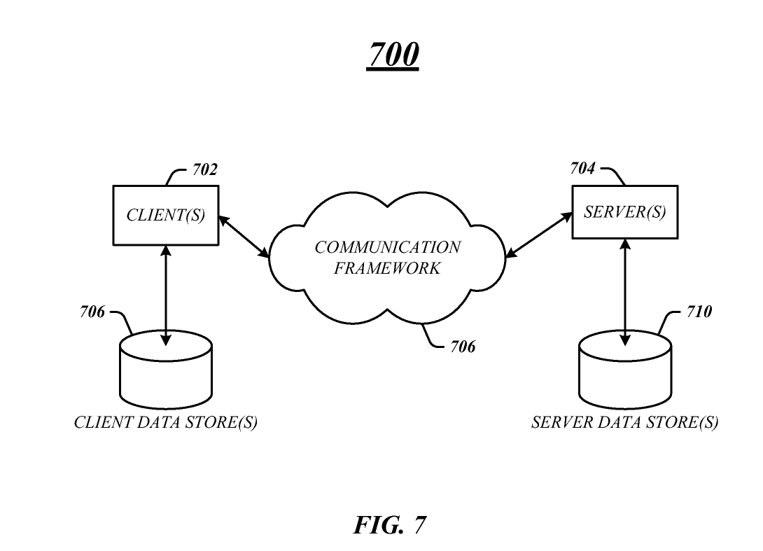

FIG. 7 illustrates a block diagram of an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, and so forth. The embodiments, however, are not limited to implementation by the communications architecture 700.

As shown in FIG. 7, the communications architecture 700 comprises includes one or more clients 702 and servers 704. The clients 702 may implement one or more components of VTC system 110 or 200, such as event detector 220 and camera selection logic 230. The servers 704 may implement one or more components of VTC system 110 or 200, such as video conferencing module 240. The clients 702 and the servers 704 are operatively connected to one or more respective client data stores 708 and server data stores 710 that can be employed to store information local to the respective clients 702 and servers 704, such as cookies and/or associated contextual information.

The clients 702 and the servers 704 may communicate information between each other using a communication framework 706. The communications framework 706 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 702 and the servers 704 may include various types of standard communication elements designed to be interoperable with the communications framework 706, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 702 and a server 704 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving video information from a plurality of video cameras in a room;
detecting an event of interest from the video information;
determining which of the plurality of video cameras has an optimal view of the detected event, according to at least one parameter; and
selecting the video feed from the determined video camera to feed to a remote location.

2. The method of claim 1, wherein detecting an event of interest comprises:
detecting at least one of a person, a face, an eye gaze direction, a motion, a head direction, an active speaker, or a presence in a specified location.

3. The method of claim 2, wherein detecting an event of interest comprises:
detecting a target from a direction of eye gaze of a majority of people in the room and selecting the target as the event of interest.

4. The method of claim 2, wherein detecting an event of interest comprises:
detecting a person standing in front of a presentation area as the event of interest.

5. The method of claim 1, wherein the parameters for selecting an optimal view comprise at least one of a camera location, a camera field of view, a distance to the detected event, a view of the detected event, a zoom, or a resolution.

6. The method of claim 5, wherein determining the video camera with an optimal view comprises:
calculating a score from one of a plurality of measures comprising one of:
a percentage of a camera field of view filled with the detected event;
a completeness in a field of view of the front of a face associated with the detected event;
a resolution of the video cameras with a view of the detected event; or
a proximity to the detected event of the video cameras with a view of the detected event; and
selecting the video camera with the highest score.

7. The method of claim 6, wherein calculating the score comprises calculating a weighted score of at least two of the measures.

8. The method of claim 1, comprising determining the video camera with the optimal view from a pre-set comprising a location within the room and the video camera to select for that location when the location is detected in an event of interest.

9. An article comprising a storage medium containing instructions that when executed cause a system to:
detect an event of interest from video information received from a plurality of video cameras in a room;
determine which of the plurality of video cameras has a view of the detected event according to at least one parameter; and
select the video feed from the determined video camera to feed to a remote location.

10. The article of claim 9, wherein the instructions to detect an event of interest comprise instructions that when executed cause the system to detect at least one of a person, a face, an eye gaze direction, a motion, a head direction, an active speaker, or a presence in a specified location.

11. The article of claim 10, wherein the instructions to detect an event of interest comprise instructions that when executed cause the system to, at least one of:
detect a target from a direction of eye gaze of a majority of people in the room and select the target as the event of interest;
detect a target from a head direction of a majority of people in the room and select the target as the event of interest; and
detect a person standing in front of a presentation area as the event of interest.

12. The article of claim 9, wherein the parameters for selecting a view comprise at least one of a camera location, a camera field of view, a distance to the detected event, a view of the detected event, a zoom, or a resolution.

13. The article of claim 12, wherein the instructions to determine the video camera with a view comprise instructions that when executed cause the system to:
calculate a score from one of a plurality of measures comprising at least one of:
a percentage of a camera field of view filled with the detected event;
a completeness in a field of view of the front of a face associated with the detected event;
a resolution of the video cameras with a view of the detected event; or
a proximity to the detected event of the video cameras with a view of the detected event; and
select the video camera with the highest score.

14. The article of claim 9, further comprising instructions that when executed cause the system to determine the video camera with the optimal view from a pre-set comprising a location within the room and the video camera to select for that location when the location is detected in an event of interest.

15. An apparatus, comprising:
a logic device; and
camera selection logic operative on the logic device to receive an event of interest detected in video data from a plurality of video cameras in a room, select which of the plurality of video cameras has an optimal view of the detected event, according to at least one parameter, and to provide the video feed of the selected camera for output to a remote location.

16. The apparatus of claim 15, wherein the parameters for selecting an optimal view comprise at least one of a camera location, a camera field of view, a distance to the detected event, a view of the detected event, a zoom, or a resolution.

17. The apparatus of claim 16, the camera selection logic further operative to:
calculate a score from one of a plurality of measures comprising at least one of:
a percentage of a camera field of view filled with the detected event;
a completeness in a field of view of the front of a face associated with the detected event;
a resolution of the video cameras with a view of the detected event; or
a proximity to the detected event of the video cameras with a view of the detected event;
calculate a weighted score when more than one measure is used; and
select the video camera with the highest score.

18. The apparatus of claim 15, the camera selection logic further operative to determine the video camera with the optimal view from a pre-set comprising a location within the room and the video camera to select for that location when the location is detected in an event of interest.

19. The apparatus of claim 15, comprising an event detector operative to receive video data from a plurality of video cameras in a room and to detect an event of interest from the video data.

20. The apparatus of claim 15, comprising a video conferencing module operative to transmit the selected video feed and audio information from the room to other video conferencing modules located in other rooms, receive video and audio information from the other video conferencing modules, and display the received video and audio information.
